(19) United States
(12) Patent Application Publication
(10) Pub. No.: US 2006/0136344 A1
(43) Pub. Date: Jun. 22, 2006

(54) Web-based business application with streamlined integration of upsell features

(75) Inventors: Jeffrey A. Jones, Larkspur, CA (US); Evan M. Goldberg, Woodside, CA (US); Jingwei Liang, Castro Valley, CA (US); Alan S. Liu, Redwood City, CA (US)

Correspondence Address: BRIAN J. DAIUTO, 886 ILIMA COURT, PALO ALTO, CA, 94306, US

(73) Assignee: NETSUITE, INC.

(21) Appl. No.: 11/016,087

(22) Filed: Dec. 17, 2004

(51) Int. Cl. G06F 17/30

(52) U.S. Cl. 705/402

(57) ABSTRACT

A method, system, computer program product, and related business methods are described for providing streamlined integration of upsell features into a web-based business application. In one preferred embodiment, upsell source criteria are conveniently submitted by the user in a wizard-based process. The user can select from several upsell actions to be automatically executed based upon the presented results, thereby facilitating workflows associated with the upselling process. In another preferred embodiment, responsive to a single-click or no-click user command into a web page displaying a customer information record, a pre-computed list of upsell items is presented to the user for convenient and timely viewing. In another preferred embodiment, responsive to any of a variety of user activity that instantiates a listing of items, an upsell option is also provided in relation to that listing of items. Upon selection of that upsell option, one or more upsell possibilities corresponding to the listed of items is computed and displayed for convenient and timely viewing.

### FIELD

This patent specification relates to web-based business applications. More particularly, this patent specification relates to a method, system, computer program product, and related business methods for streamlined integration of upsell features into a web-based business application.

### BACKGROUND

Successful, sustainable business enterprises often use cross-selling and up-selling as important components of their sales and marketing strategies. Although usage of these terms can vary among different environments, cross-selling usually refers to marketing new products to current customers based on their past purchases, while up-selling usually refers to moving customers from less profitable items in a category to more profitable items in the same category. In both cases, knowledge relating to a first set of items (e.g., past purchases, a currently contemplated purchase, a currently known opportunity, etc.) is leveraged for identifying a second set of items (e.g., complementary items, more lucrative items, etc.) to sell. For clarity of presentation, the term “upsell” is used herein to broadly reference the practice of identifying a second set of sales possibilities based on a first set of realized or unrealized sales possibilities. Thus, for example, in addition to encompassing the above cross-selling and up-selling activities, “upselling” also refers herein to identifying current customers likely to buy a particular item (e.g., an overstocked item), finding items that an identified customer is more likely to buy, and identifying a second set of items likely to be purchased in conjunction with a first set of items. As used herein, “item” refers broadly to anything that can be sold, including goods, services, rights, warranties, etc.

The ability of business users to manage crucial business information has been greatly enhanced by the proliferation of IP-based networking together with advances in object oriented Web-based programming and browser technology. Using these advancements, systems have been developed that permit web-based access to business information systems, thereby allowing any user with a browser and an Internet or intranet connection to view, enter, or modify the required business information.

As used herein, the term web-based business application or web-based business information system generally refers to a business software system having browser-based access such that an end user requires only a browser and an Internet/intranet connection on their desktop, laptop, network appliance, PDA, etc., to obtain substantially complete access to that system. Examples of web-based business applications include those described in the commonly assigned US2004/0199541A1, US2004/0199543A1, U.S. Ser. No. 10/796,718, and U.S. Ser. No. 10/890,347, each of which is incorporated by reference herein. Further examples of web-based business applications include application service provider (ASP) hosted services provided by NetSuite, Inc. of San Mateo, Calif. such as NetSuite™, NetSuite™ Small Business, NetCRM™, NetERP™, and NetCommerce™, descriptions of which can be found at www.netsuite.com. A further example of a web-based business application is discussed at www.salesforce.com. Web-based business applications can also be implemented using non-ASP models having different hosting mechanisms, such as with self-hosted systems in which a business enterprise operates and maintains its own private, captive business information system having browser-based access across an intranet and/or the Internet.

A commercial enterprise can achieve many functional and strategic advantages by using a web-based business information system comprising integrated ERP (Enterprise Resource Planning), CRM (Customer Relationship Management), and other business capabilities. Because substantially all of the enterprise's business information is in one place, including sales histories, inventory levels, and customer profitability data, substantial advantages can be enjoyed by mining that data to achieve profitable business insights.

However, problems can arise in properly integrating data mining tools into a practical web-based business application environment. The success of a web-based business application hinges not only on the availability of powerful capabilities, but also on whether these capabilities are placed within the practical, everyday grasp of end users. The additional capabilities should be perceived as tools that readily resolve existing problems, that readily integrate into the existing workflow, and that make existing life easier, rather than harder, for the end user. Another challenge faced in the web-based business application environment relates to server load and network latencies, bringing about the need for judicious solutions relating to the types of data mined, the overall amount of statistical computation performed, the degree to which computation is split among various system components, and the volume of data sent over the Internet (and/or intranet) to the user's web browser.

Accordingly, it would be desirable to provide a web-based business application having integrated features that facilitate the upselling process.

It would be further desirable to provide such integrated upsell features in a manner that makes them easy to learn, easy to use, and quickly available to end users.

It would be still further desirable to provide such integrated upsell features in a manner that complements and leverages other workflow solutions in the web-based information system.

### SUMMARY

A method, system, computer program product, and related business methods are provided in which upsell features are integrated into a web-based business application in a manner that facilitates upselling workflow and complements other user activity. In one preferred embodiment, upsell source parameters are conveniently submitted by the user in a wizard-based process. The user can select from several upsell actions to be automatically executed based upon the presented results, thereby facilitating workflows associated with the upselling process. By way of example, the upsell actions can include creating and automatically populating an opportunity record, automatically creating task records for personnel associated with the results, automatically scheduling phone calls based on the results, and automatically generating customer groups associated with the results. In one preferred embodiment, it has been found that computations based on pairwise, customerwise correlations among items provides for sufficient precision in the upselling process for many purposes, and is particularly advantageous in a web-based business application environment as demands on server load and network traffic are kept relatively modest.

In another preferred embodiment, responsive to a single-click or no-click user command into a web page displaying a customer information record, a pre-computed list of upsell items is presented to the user for convenient and timely viewing. In another preferred embodiment, responsive to any of a variety of user activity that instantiates a listing of items, an upsell option is also provided in relation to that listing of items. By way of example, the upsell option can be presented in the form of a button placed near the item list. Upon selection of the upsell option, one or more upsell possibilities corresponding to the listed of items is computed and displayed for convenient and timely viewing. In another preferred embodiment, these displayed upsell possibilities are individually user-selectable for single-click addition to the item list.

### BRIEF DESCRIPTION OF THE DRAWINGS

FIG. 1 illustrates a conceptual diagram of a computer network including an enterprise network and a web-based business information system according to a preferred embodiment;

FIG. 2 illustrates a conceptual diagram of an upsell database according to a preferred embodiment;

FIG. 3 illustrates generating and providing an upsell item listing according to a preferred embodiment;

FIG. 4 illustrates a customer information record including access to upsell information according to a preferred embodiment;

FIG. 5 illustrates an upsell items list according to a preferred embodiment;

FIG. 6 illustrates generating and providing upsell information according to a preferred embodiment;

FIG. 7 illustrates an opportunity record including an item listing and a nearby upsell option button according to a preferred embodiment;

FIG. 8 illustrates an upsell possibility pop-up window corresponding to the item listing of FIG. 7;

FIG. 9 illustrates a transactions record including an item listing and a nearby upsell option button according to a preferred embodiment;

FIG. 10 illustrates an upsell possibility pop-up window corresponding to the item listing of FIG. 9;

FIG. 11 illustrates a wizard-based upsell source criteria entry process and upsell action instantiation process according to a preferred embodiment;

FIG. 12 illustrates upsell source parameter entry screens according to a preferred embodiment;

FIG. 13 illustrates a screen from FIG. 12 upon entry of a search command;

FIG. 14 illustrates a filter customer list screen for filtering upsell results according to a preferred embodiment;

FIG. 15 illustrates a customer selection screen according to a preferred embodiment;

FIG. 16 illustrates an upsell action menu screen according to a preferred embodiment;

FIG. 17 illustrates an action verification screen and a task record automatically generated according to a preferred embodiment;

FIG. 18 illustrates upsell source parameter entry screens according to a preferred embodiment;

FIG. 19 illustrates a filter customer list screen and a customer selection screen according to a preferred embodiment;

FIG. 20 illustrates an upsell action menu screen according to a preferred embodiment; and

FIG. 21 illustrates an action verification screen and an opportunity record including automatically populated upsell items list according to a preferred embodiment.

### DETAILED DESCRIPTION

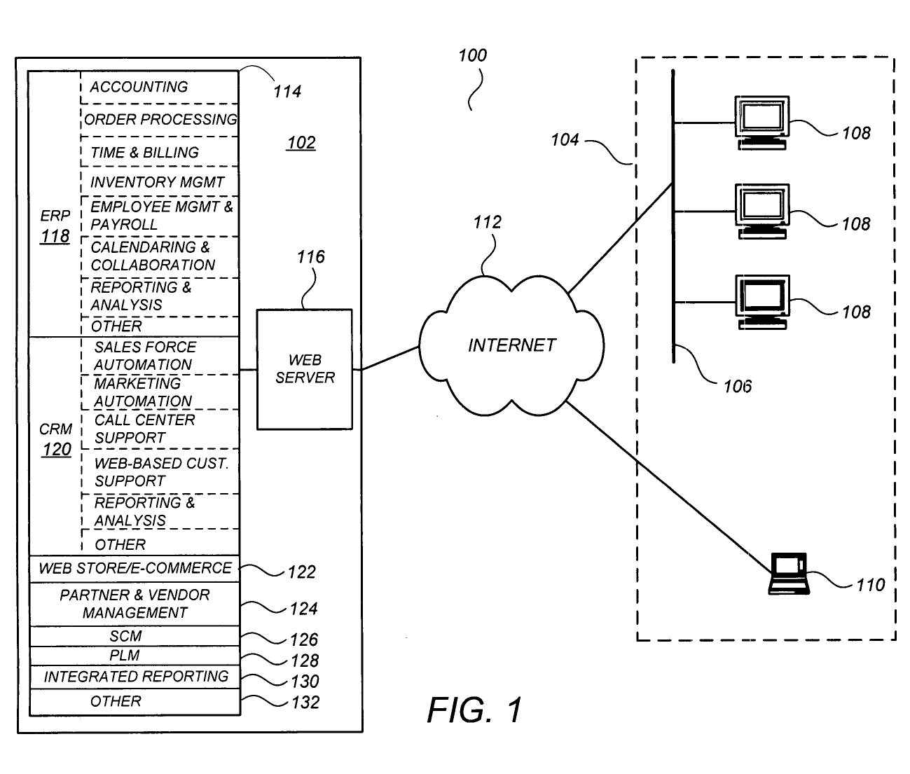

FIG. 1 illustrates a conceptual diagram of a network 100 including a web-based business application 102 and an enterprise network 104 into which the features and advantages of one or more preferred embodiments may be realized. Enterprise network 104 is associated generally with a business enterprise that may be as small as a single-employee sole proprietorship or as large as a multinational corporation having many different facilities and internal networks spread across many continents. Alternatively, and in accordance with the advantages of an application service provider (ASP) model, the business enterprise may comprise no dedicated facilities or business network at all, provided that its end users have access to an internet browser and an internet connection. For simplicity and clarity of explanation, the enterprise network 104 is simply represented by an on-site local area network 106 to which a plurality of personal computers 108 is connected, each generally dedicated to a particular end user although such dedication is not required, along with an exemplary remote user computer 110 that can be, for example, a laptop computer of a traveling employee having internet access through a hotel, coffee shop, a public Wi-Fi access point, or other internet access modality. The end users associated with computers 108 and 110 may also each possess a personal digital assistant (PDA) such as a Blackberry, Palm, Handspring, or other PDA unit having wireless internet access and/or cradle-based synchronization capabilities. Users of the enterprise network 104 interface with the web-based business application 102 across the Internet 112.

Web-based business application 102, which in this example is a dedicated third party ASP, comprises an integrated business server 114 and a web server 116 coupled as shown in FIG. 1. It is to be appreciated that either or both of the integrated business server 114 and the web server 116 may actually be implemented on several different hardware systems and components even though represented as singular units in FIG. 1. Integrated business server 114 comprises an ERP functionality as represented by ERP module 118, and further comprises a CRM functionality as represented by CRM module 120. It is to be appreciated that identification herein of business functionalities with modules does not limit the scope of the preferred embodiments to segregated units thereof. In many preferred embodiments the ERP module 118 may share methods, libraries, databases, subroutines, variables, etc., with CRM module 120, and indeed ERP module 118 may be intertwined with CRM module 120 into a larger integrated code set without departing from the scope of the preferred embodiments.

It is to be appreciated that FIG. 1 is a simplified conceptual illustration presented so as to clearly describe the preferred embodiments herein. A variety of computing, storage, and networking hardware associated with the enterprise network 104 and the web-based business application 102, such as e-mail servers, databases, application servers, internet gateways, internal and external routers, security devices, internet service provider facilities, and related software protocols and methods necessary for operation are known in the art and need not be detailed here. Examples of such known computing, storage, and networking hardware can be found, for example, in US2002/0152399A1 and US2002/0169797A1, which are incorporated by reference herein. Similarly, in view of the present disclosure, a person skilled in the art would be able to construct software packages capabie of achieving the transaction information storage, correlation computation, and various user interface features and functionalities described herein without undue experimentation, using publicly available programming tools and software development platforms. Various data mining packages have been proposed, such as those described in WO02/27529A2, which is incorporated by reference herein. However, there remains a need for judiciously integrating an appropriate set of data mining functionalities into the particular environment of a web-based business application in a manner that promotes their everyday use by a wide variety of users, including customer-facing users at the front lines of business, during the course of their customer-facing activities.

In a preferred embodiment similar to NetSuite™, supra, the ERP module 118 comprises an accounting module, an order processing module, a time and billing module, an inventory management module, an employee management and payroll module, a calendaring and collaboration module, a reporting and analysis module, and other ERP-related modules. The CRM module 120 comprises a sales force automation (SFA) module, a marketing automation module, a contact list module (not shown), a call center support module, a web-based customer support module, a reporting and analysis module, and other CRM-related modules. The integrated business server further 114 further provides other business functionalities including a web store/e-commerce module 122, a partner and vendor management module 124, and an integrated reporting module 130. These functionalities are preferably integrated and executed by a single code base accessing one or more integrated databases as necessary. In another preferred embodiment, an SCM module 126 and PLM module 128 is provided. Web server 116 is configured and adapted to interface with the integrated business server 114 to provide web-based user interfaces to end users of the enterprise network 104. Version 10.0 of the NetSuite™ product line, on public sale by NetSuite, Inc. of San Mateo, Calif. as of September 2004, represents one example of a web-based business application with streamlined integration of upsell features according one or more of the preferred embodiments described herein.

In an alternative preferred embodiment (not shown), one or more of the above business modules may be implemented by functionally separate servers and/or platforms that communicate with each other and with an integration server (not shown) over a LAN, a WAN, or the Internet. Protocols that may be used to facilitate inter-server communications include smbXML and qbXML. It is to be appreciated that the scope of the preferred embodiments is not limited to the scenario of FIG. 1 in which the web-based business application 102 is an integration of many different business functionalities. In other preferred embodiments, the web-based business application 102 may consist only of an SFA system and an ERP system. In still other preferred embodiments, the web-based business application 102 may comprise different combinations of these functionalities.

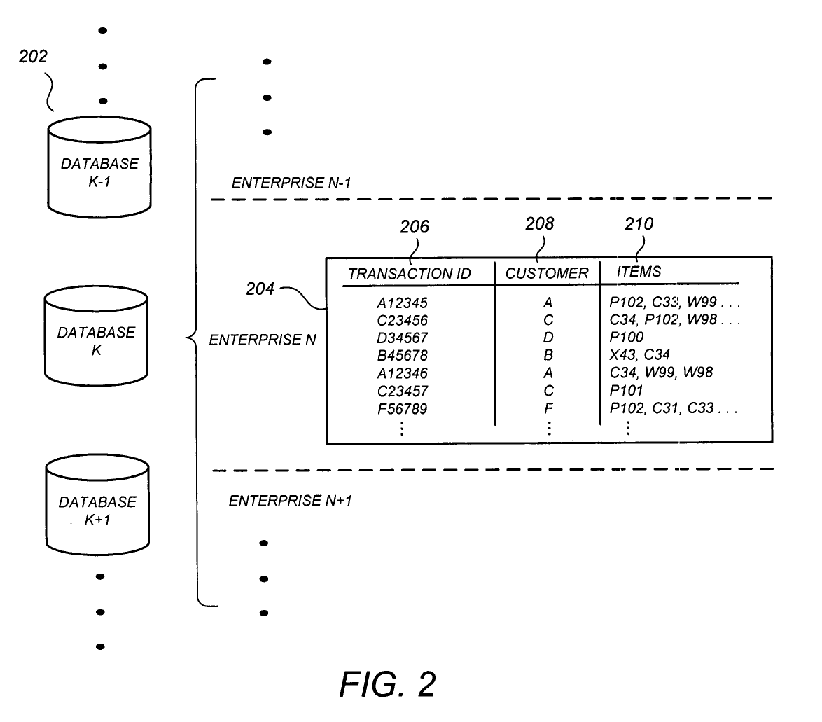

FIG. 2 illustrates a conceptual diagram of an upsell database 204 according to a preferred embodiment. As used herein, upsell database refers to a database of information sufficient to compute the upsell recommendations referenced herein for a particular enterprise. Notably, the upsell database 204 can be formed across different databases having different purposes, provided that the required information can be extracted therefrom.

In an ASP-provided implementation of a web-based business application, it is common for a plurality of different enterprises to have their data stored on a single database. Accordingly, FIG. 2 illustrates databases 202 (K−1, K, and K+1), each hosting the entirety of business data for a plurality of enterprises. Further to the ASP model, the databases 202 are coupled to plurality of application servers (not shown) programmed to serve client-side requests using, for example, Oracle Application Server Containers for J2EE (OC4J) or other appropriate system. The application servers are, in turn, coupled to a plurality of web servers. The web servers can run conventional web server software, such as Apache, Microsoft-IIS, Netscape-Enterprise, Oracle HTTP Server, etc., on conventional operating systems such Linux, Solaris, Unix, HP-UX, FreeBSD, etc. loaded onto conventional web server hardware.

As illustrated in FIG. 2, the upsell databases 204 are preferably segregated on a per-enterprise basis. Thus, the enterprises N−1, N, and N+1 in FIG. 2 each have their own upsell database 204. However, the scope of the preferred embodiments is not necessarily so limited. Data is usually stored on a per-transaction basis, each transaction having at least a transaction ID 206, a customer ID 208, and an item ID listing 210, along with other information such as date, price, etc. (not shown).

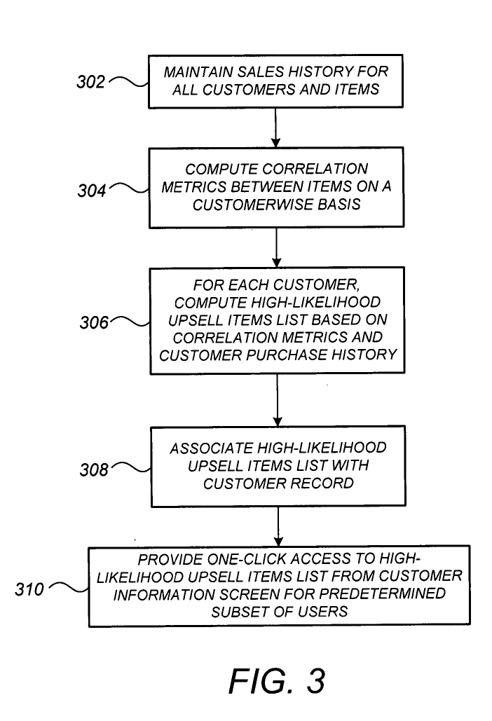

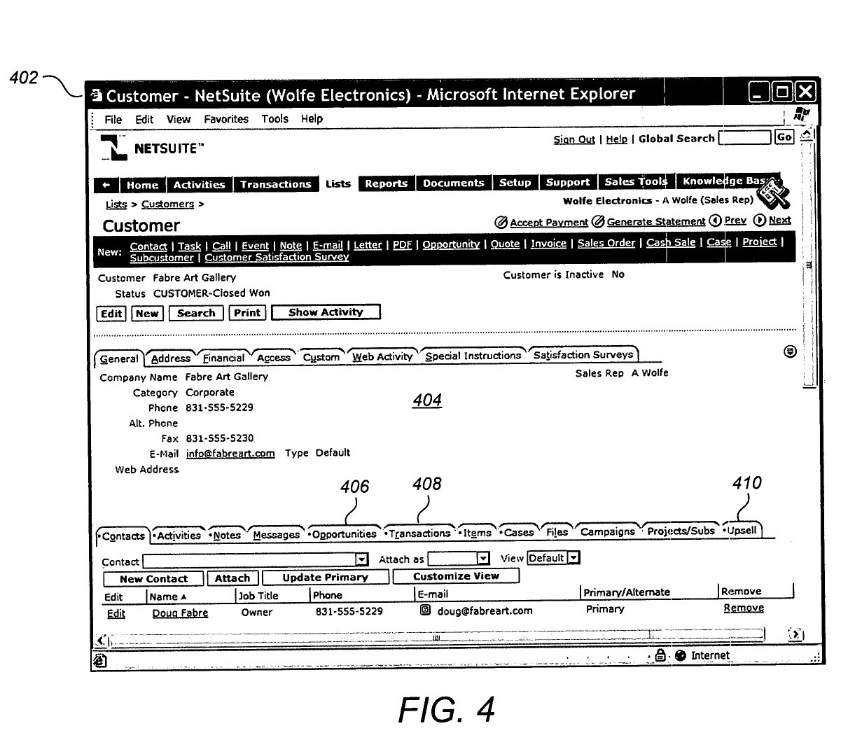

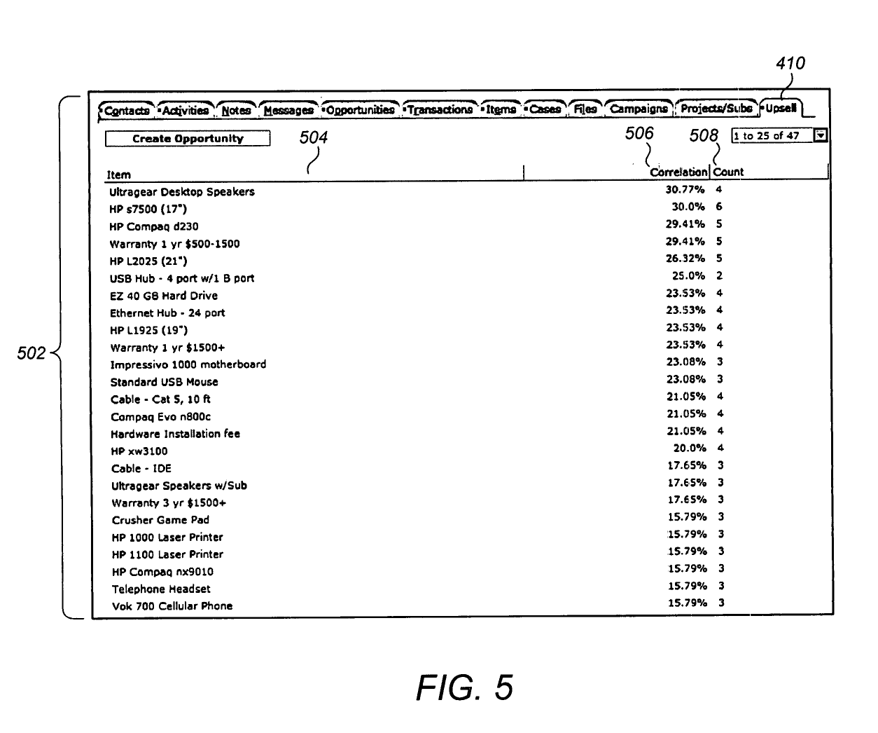

FIG. 3 illustrates generating and providing an upsell item listing according to a preferred embodiment, and can be further understood in relation to FIGS. 4 and 5. At step 302, a sales history is maintained for all customers and items of the enterprise. This can be over a predetermined data retention period (e.g., a rolling 2-year calendar) or can be perpetual. As discussed previously, this data forms at least a part of the upsell database 204 of FIG. 2. At step 304, correlation metrics are computed between items on a customerwise basis. The correlation metrics can be associated with a predetermined time period (e.g., the preceding 12-month period), or can be based on all available transaction history in the upsell database 204. By customerwise basis, it is meant that correlations are drawn between two items if they were purchased by the same customer within the predetermined time period, and it is not necessary that they be purchased during the same transaction or be purchased within any particular interval of the predetermined time period. A customerwise basis can be contrasted with a transaction-wise basis, in which correlation between two items is drawn only if they were purchased in the same transaction. Preferably, the correlation metrics at step 304 are pairwise correlations, i.e. correlations between groups of two items. Pairwise correlations can be contrasted with higher-dimensional correlations, e.g., in terms of three or more items purchased by the same customer, or in terms of sub-groupings of those three or more items as mapped against other sub-groupings for each customer.

By way of example and not by way of limitation, if an enterprise sells four items A, B, C, and D, the computation of pairwise, customerwise correlation metrics would include the following. A first correlation metric AB would comprise the percentage of customers buying A in the predetermined time period who also bought item B in the predetermined time period. A second correlation metric AC would comprise the percentage of customers buying A in the predetermined time period who also bought item C in the predetermined time period, and so on for pairwise, customerwise correlation metrics AD, BA, BC, BD, CA, CB, CD, DA, DB, and DC. Notably, during any particular “batch” computation of upsell items for all customers, these correlation metrics only need to be computed once. For each correlation metric, any of variety of statistical reliability measures can be associated. In a web-based business application, one particularly convenient statistical reliability measure comprises, for a correlation metric AB, a direct count of the number of customers who actually did buy both A and B in the predetermined

At step 306, for each of the enterprise's customers, an upsell items list is computed based on the above pairwise, customerwise correlation metrics and each customer's purchase history. More particularly, for each item purchased by the customer, a corresponding set of item pairs (each pair including that item) having relatively high correlation metrics is identified. By way of example, if the customer purchased M different items during the predetermined time interval, there will be M corresponding sets of item pairs generated for that customer, each item pair in each set being characterized by a correlation metric. The determination of what constitutes a relatively high correlation metric can be based on a preset absolute threshold, or can simply comprise an upper predetermined percentage of the number of items in a particular set. The corresponding sets of item pairs can then be combined in any of a variety of ways to generate a single upsell item list comprising the non-purchased members of the item pairs. In one preferred embodiment, the corresponding sets are combined by simply selecting, among all item pairs in all sets, those items pairs having the highest correlation metrics. On other preferred embodiments, weight can be given to more lucrative items when forming the upsell item list. Preferably, the upsell items list is filtered to exclude any items already purchased by the customer in the predetermined time period. At step 308, the upsell item list for each customer is associated with one or more customer information records, and at step 310 one-click or no-click access is provided to the upsell items list from that customer information record.

FIG. 4 illustrates a browser window 402 in which a user accesses the web-based business application 102, the browser window 402 including a customer information record 404. Included among a variety of useful information in the customer information record 404 is an opportunities tab 406 for causing a display of an opportunities list, a transactions tab 408 for causing a display of a transactions list, and an upsell tab 410 for causing a display of the upsell item list for that customer. Upon a single click of the upsell tab 410, the customer is shown an upsell item list for that customer (see FIG. 5, 502), preferably as a continuation of the same customer information record 404 within the browser window 402. As illustrated in FIG. 5, the upsell item list 502 includes recommended upsell items 504, a correlation metric 506, and a count 508.

In another preferred embodiment, the upsell items list 502 can be displayed responsive a no-click command such as a rollover or a general expand-all command in which all tabs (e.g., Contacts, Activities, Notes, Messages, etc) are expanded in the customer information record 404. In other preferred embodiments, the browser window 402 may comprise other information displays that are tied to a particular customer (e.g., an invoice for that customer, or a collections report for that customer, etc.), and the upsell tab 410 or similar one-click launch is provided in conjunction with that other information display. Advantageously, a simple, pre-computed list of upsell items is available for that customer with very little effort by the user. Moreover, that customer is likely to already be in the forefront of the user's attention by virtue of the customer record being displayed, and therefore the easily-accessed upsell item listing is timely and relevant for the user.

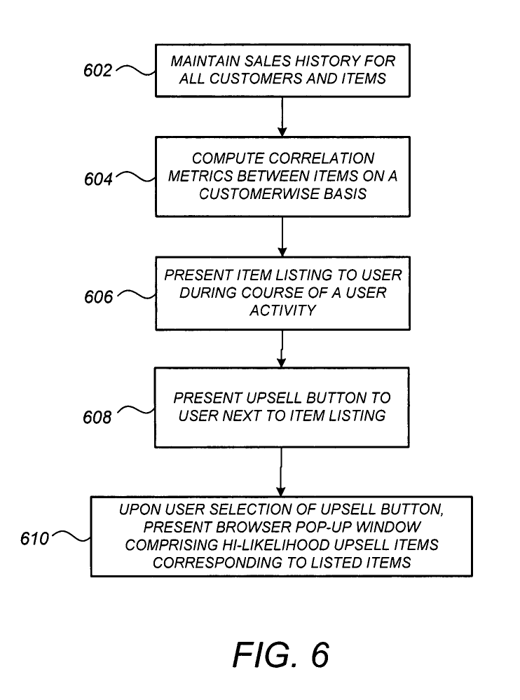

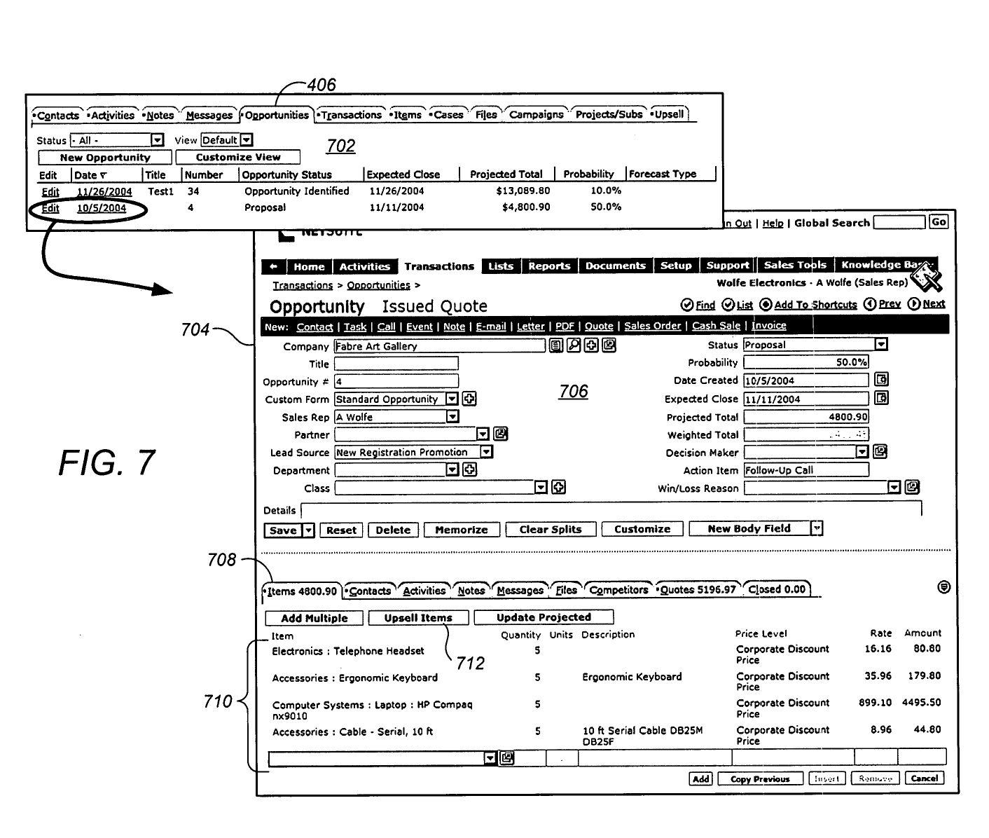

FIG. 6 illustrates generating and providing upsell information according to a preferred embodiment, and can be further understood in relation to FIGS. 6-9. Steps 602 and 604 proceed in a manner similar to steps 302 and 304 of FIG. 3, supra, resulting in the availability of pairwise, customerwise correlation metrics among enterprise items. At step 606, a list of items is presented to the user during the course of their everyday activity according to an existing functionality of the web-based business application. Thus, for example, FIG. 7 illustrates an opportunity record 706 of a browser window 704 launched from a link in an opportunities list 702 that, in turn, was displayed responsive to selection of the opportunities tab 406 of FIG. 4. Under an items tab 708 in the opportunity record 706 is a listing of items 710, in this case being items associated with a particular opportunity. Opportunity records are known in the art and are used in establishing, tracking, and reporting on sales opportunities. Opportunity records can also facilitate transaction entry upon consummation of the sales opportunity. The particular list of items 710 may, or may not be, very important to the user, depending on a wide variety of circumstances surrounding that particular opportunity, and in view of the many different ways such lists can come together. Regardless of its particular importance, however, according to a preferred embodiment, single-click access is provided to an upsell items list directly based on that particular items list 710, which may advantageously be used for any of a variety of purposes.

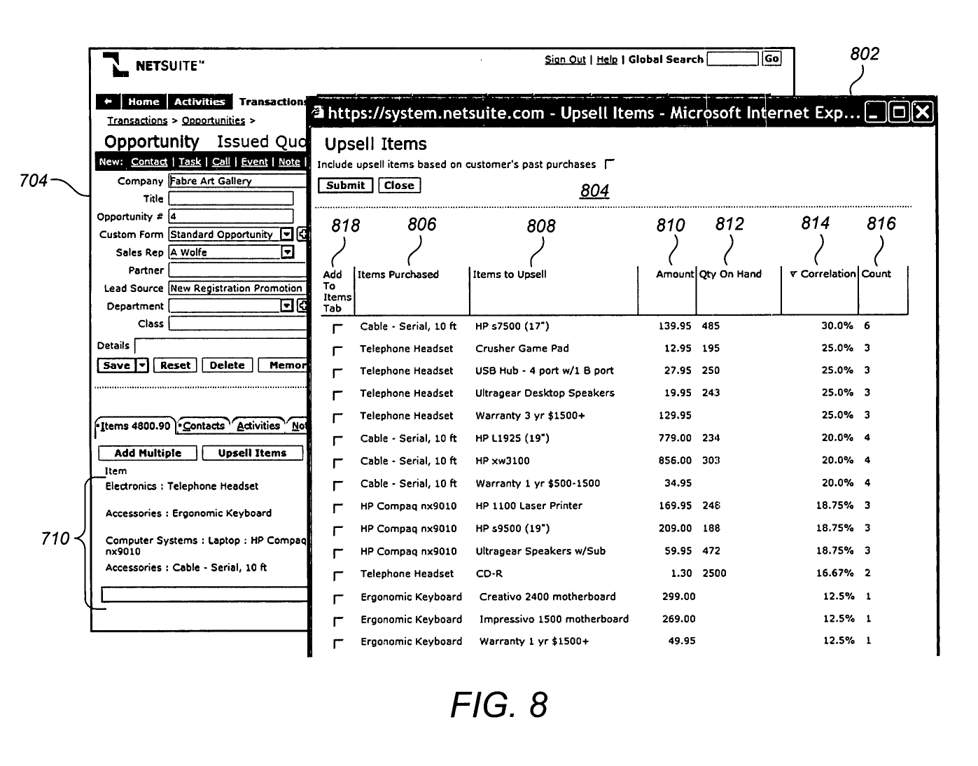

More particularly, at step 608, an upsell option such as the Upsell Items button 712 is displayed next to the list of items 710. At step 610, upon selection of the upsell option, a listing of upsell items based on the listed items 710 is displayed. FIG. 8 illustrates a pop-up browser window 802 including an upsell items list 804 launched from the Upsell Items button 712, comprising an items purchased column 806 (i.e., items in the list 710 for which correlations based on purchase history is presented), an items to upsell column 808, an amount column 810, a quantity on hand column 812, a correlation column 814, and a count column 816. Also provided is a user-selectable box 818 next to each entry in the upsell items list that facilitates easy addition of that particular upsell item to the listing 710. The upsell items listing 804 is generated by identifying, for each item in the listing 710, a corresponding set of item pairs (each pair including that item) having relatively high pairwise, customerwise correlation metrics as computed at step 604. In one embodiment, the corresponding sets of item pairs are merged into the single list 804 and ordered by correlation metric. Advantageously, immediate access to upsell ideas based on a currently displayed list is provided.

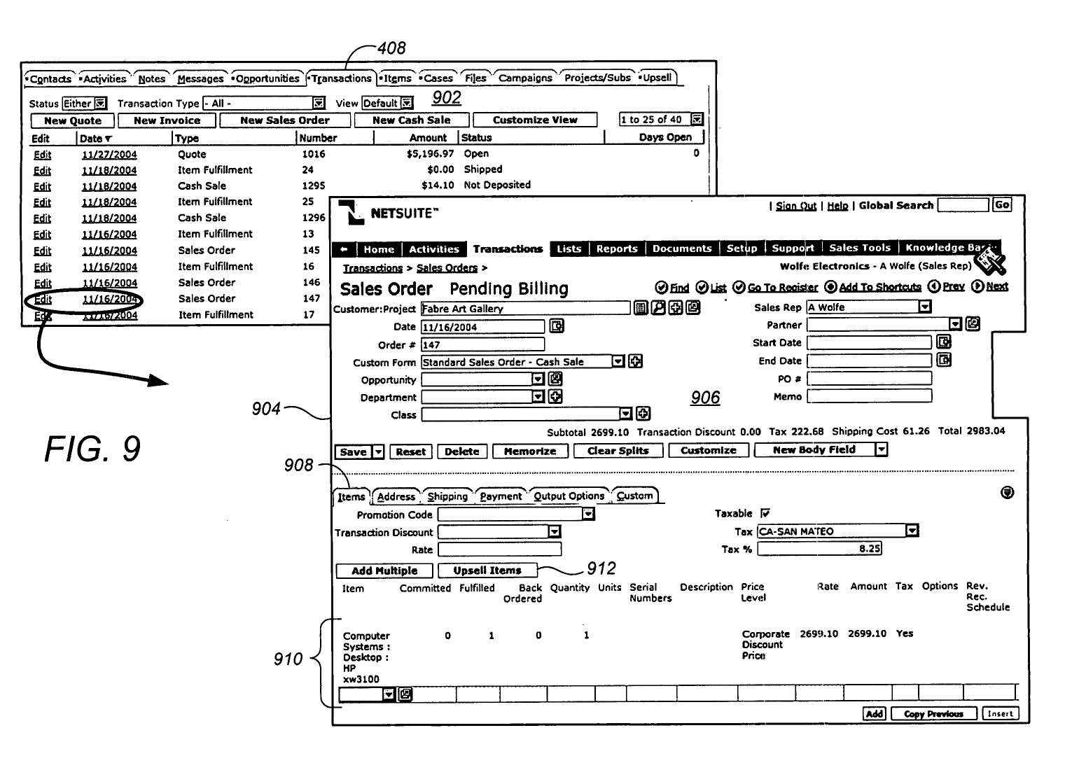

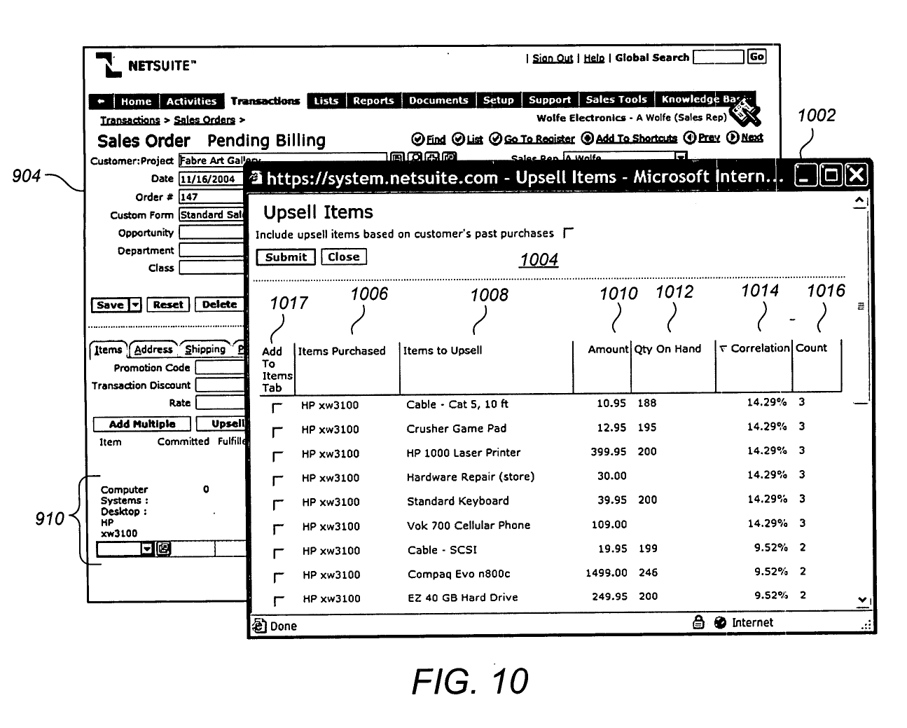

FIGS. 9 and 10 provide a further example providing of quick, easy access to upsell recommendations triggered from an item listing according to a preferred embodiment. FIG. 9 illustrates a transaction record (sales order) 906 of a browser window 904 launched from entry in a transactions list 902 that, in turn, was displayed responsive to selection of the transactions tab 408 of FIG. 4. Under an items tab 908 in the transactions record 706 is a listing of items 910, in this case being items associated with a particular transaction (a sales order). FIG. 10 illustrates a pop-up browser window 1002 including an upsell items list 1004 launched from an Upsell Items button 912 positioned near the listing of items 910, comprising columns 1006-1016 and 1017 analogous to columns 806-816 and 818, respectively, of FIG. 8.

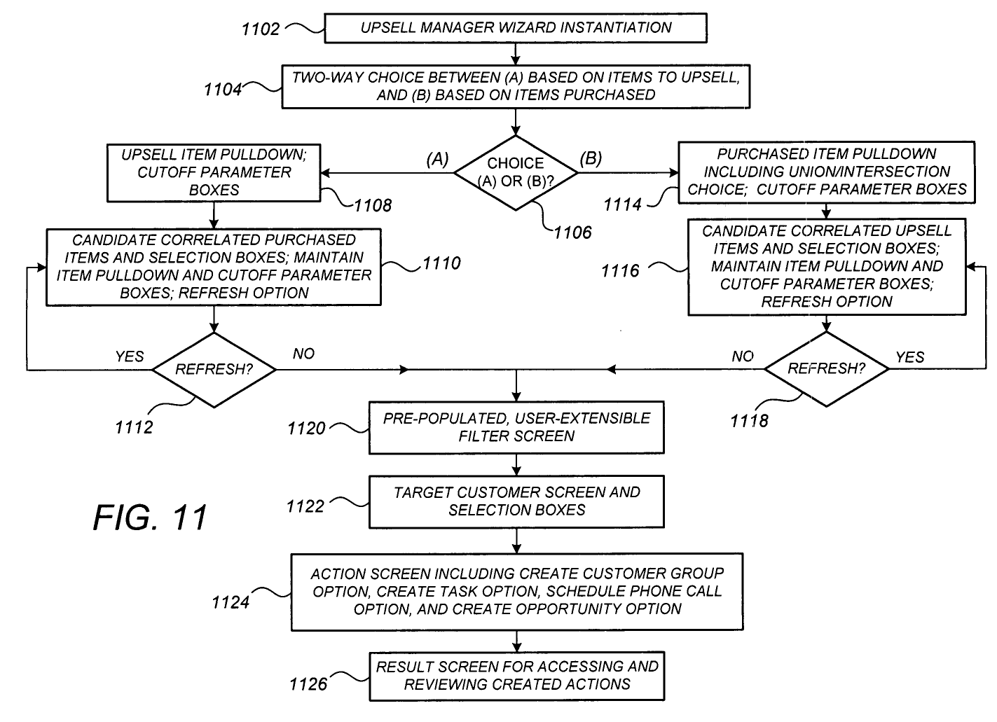

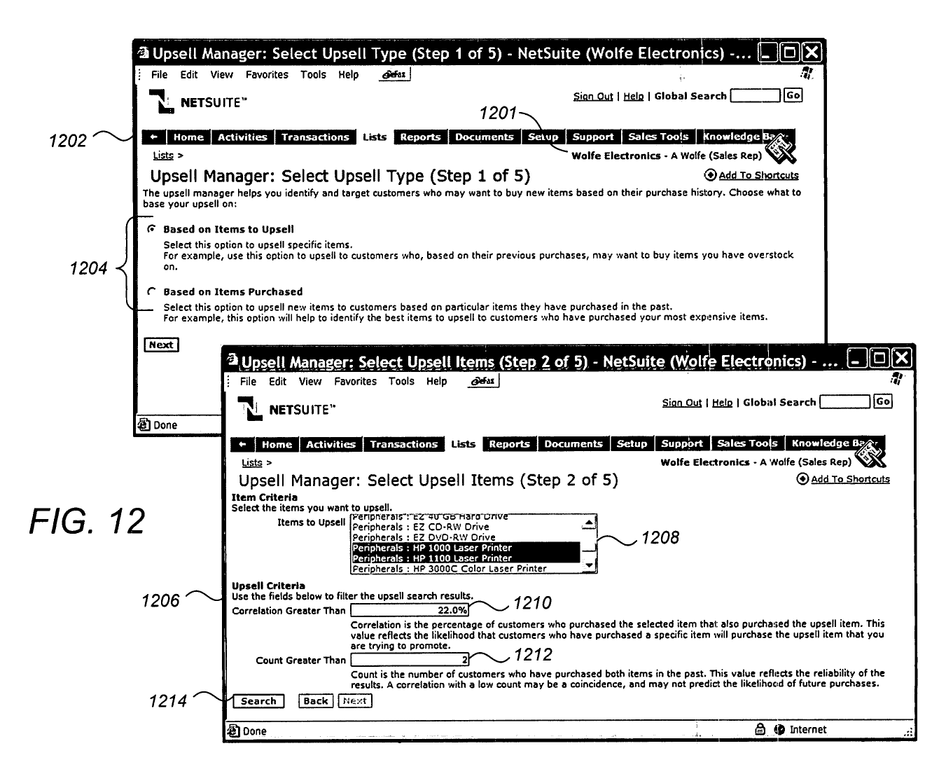

FIG. 11 illustrates a wizard-based entry process for upsell source parameters and an upsell action instantiation process according to a preferred embodiment, and can be further understood in relation to FIGS. 12-21. As used herein, upsell source parameters refers to a set of information for which corresponding upsell recommendations are desired. By way of example, upsell source parameters can include an item to upsell (e.g., an overstocked item), as well as any associated filtering and selection criteria (e.g., limiting the customer geography of the desired result set). As used herein, upsell recommendation refers to the set of information generated responsive to the upsell source parameters. For example, if the upsell source parameters comprise an item to upsell (e.g., an overstocked item), the upsell recommendation can comprise a listing of customers most likely to buy the upsell item based on their past purchases. In this case, the upsell recommendation would also include the upsell item itself (which was entered as a source parameter). By way of further example, upsell source parameters can include a purchased item, and the corresponding upsell recommendation can comprise (i) a list of upsell items likely to be purchased by customers who bought that purchased item, along with (ii) a list of customers who bought that purchased item who have not yet bought one or more of the upsell items.

At step 1102, the user instantiates an upsell manager wizard using any of a variety of lead-in methods such as pull-down entry from a menu. In general, wizard refers to a succession of related frames designed to guide a user through a multi-step task, to provide intermediate results to the user during that task (if necessary), and to provide a back up capability allowing the user to revert to previous frames to change entries with minimal or no loss of generated or entered data. Notably, in the context of the herein-described wizard, frame refers to a stepwise screen displayed to the user and not necessarily to so-called browser frames.

At steps 1104-1106, a two-way choice is entered between whether the source items (i.e., the items for which correlated items will be identified) are (i) items to upsell, or (ii) items purchased (see FIG. 12, 1204). As illustrated in FIG. 12 by enterprise identifier 1201 (Wolfe Electronics), all of the upsell computations and upsell actions to be performed are in the context of a single enterprise and its associated population of customers, items, and transactions.

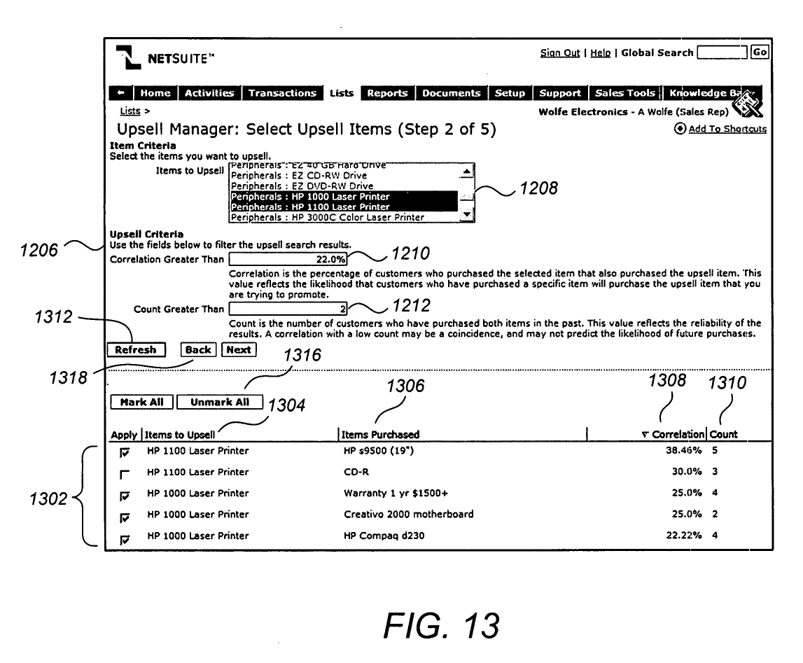

At step 1108, where items to upsell is chosen, a second frame (see FIG. 12, frame 1206) is presented comprising a pull-down menu (see FIG. 12, 1208) for selecting source items among a pre-established listing of enterprise items. The frame 1206 further provides a desired minimum correlation entry line 1210 and a desired minimum count line 1212, either of which can optionally be left blank. At step 1110, upon selection of the search button 1214, the second frame is appended with a list 1302 of user-selectable item-wise pairings of source items (items to upsell, FIG. 13, 1304) and candidate items (items purchased, FIG. 13, 1306) according to the entered minimum correlation rate and minimum count. The list 1302 further identifies correlations 1308 and counts 1310 associated with each pairing. A refresh button 1312 is provided that, upon instantiation at step 1112, allows the user to modify previous source item entries, minimum correlation rate, and/or minimum count, and to view associated intermediate results within that same second frame. Convenient mark all/unmark all buttons 1316 and back/next buttons 1318 are provided.

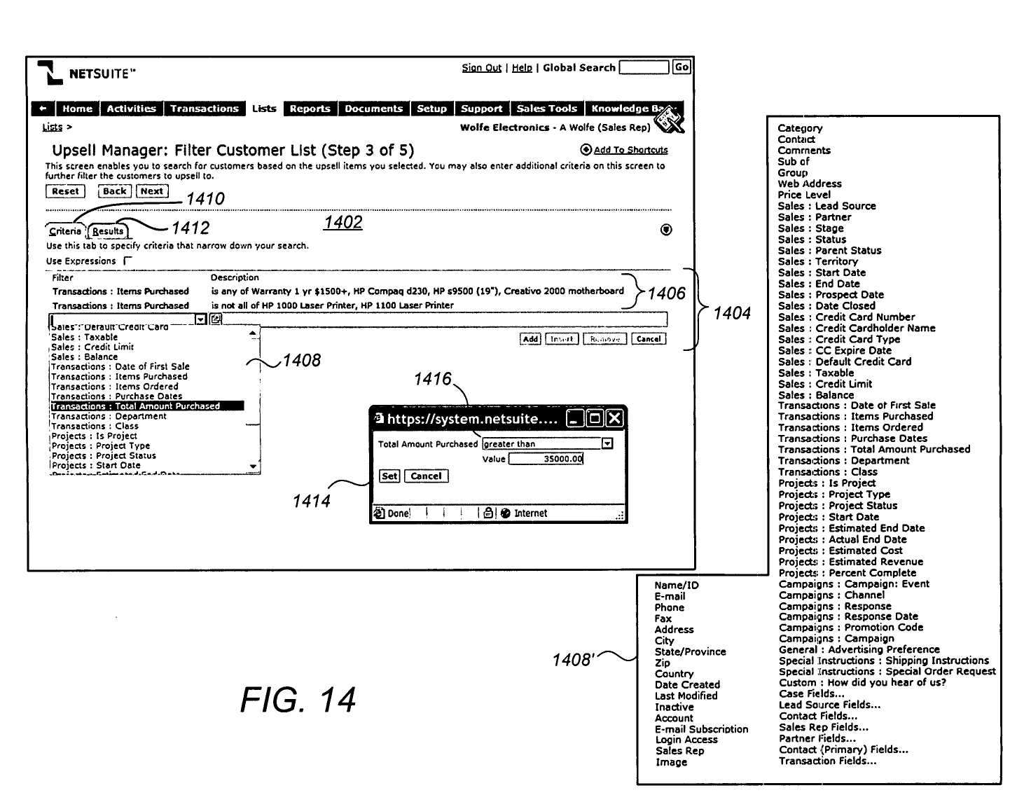

By marking a particular pairing in the list 1302, the user implicates an interest in finding candidate customers who bought that candidate item (items purchased, FIG. 13, 1306), and who thereby would be more likely to buy that source item (item to upsell, 1304). If the user decides at step 1112 to proceed, a third frame providing a pre-populated, user-extensible filter (see FIG. 14, 1402) based on the user's choices is provided at step 1120.

As illustrated in FIG. 14, the search frame 1402 comprises a listing 1404 of customer filter items, including a first set 1406 of filter items automatically populated based on the previous user choices. As indicated by the contents of the filter items 1406, those customers who bought any of the candidate items, and who did not buy all of the source items, will be identified as candidate customers. By virtue of the search frame 1402, the user may further filter out customers based on any of a variety of criteria 1408, a more complete listing being shown at 1408′. By way of example, in FIG. 14 the user is filtering out any customers who have purchased less than $35,000 over the predetermined time period, as illustrated by pop-up window 1414 including entry boxes 1416 that appeared where “Transactions: Total Amount Purchased” was selected from the pull-down menu 1408. A results tab 1412 provides the opportunity to define the particular formatting of the resulting customer list, and a criteria tab 1410 allows the user to return to the filter criteria list 1414. Notably, no user entries are required in the third frame 1402 and the user can simply click “Next” to proceed to the next screen. This increases usability for novice users while at the same time providing advanced functionality for more advanced users.

In one preferred embodiment, implicit search criteria are implemented that limit the result set according to predefined limits for the user. By way of example, if the user is a sales manager responsible for a particular geographical territory, there will be implicit search criteria to limit the results to customers within that territory. Preferably, the ability to implement such implicit criteria is provided as an enterprise-wise option that can be activated or de-activated by a system administrator or other properly authorized person.

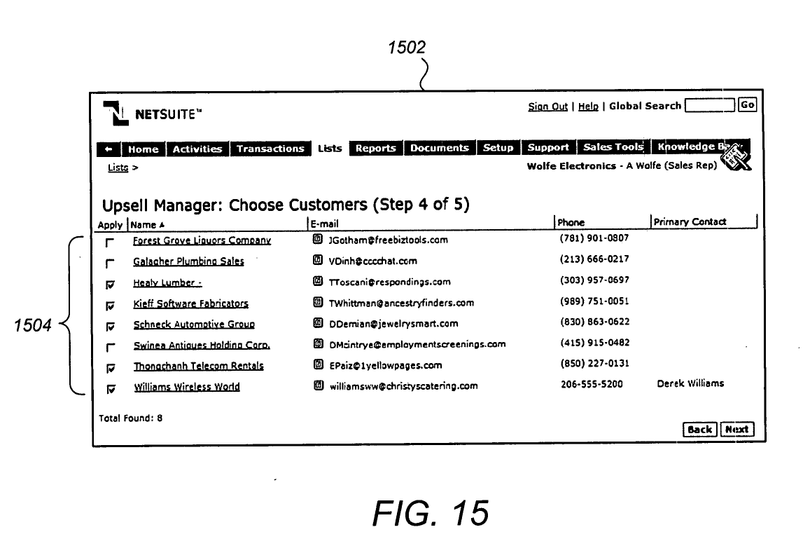

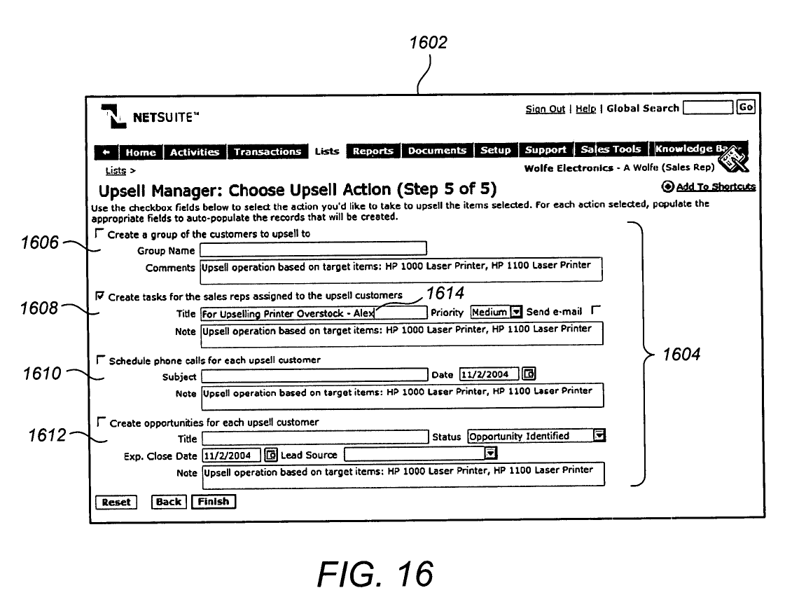

At step 1122, a fourth frame (see FIG. 15, 1502) is displayed showing the resulting candidate customers (see FIG. 15, 1504), the candidate customers being individually user-selectable. Together with the identified source items, the listing of candidate customers 1504 represents an upsell recommendation that is, in itself, a highly useful result. However, in accordance with a preferred embodiment, the power of the upselling process is further enhanced and integrated into existing workflow processes by providing the user the opportunity to instantiate one or more upsell actions in relation to selected ones of the candidate customers. At step 1124, an upsell action screen (see FIG. 16, 1602) is displayed presenting a menu 1604 of user-selectable upsell actions that can be automatically executed by the web-based business application. In the example of FIG. 16, the user-selectable upsell actions include a create customer group option 1606, a create task option 1608, a schedule phone call option 1610, and a create opportunity option 1612. Although these options represent a particularly desirable menu, any of a variety of other upsell actions are also within the scope of the preferred embodiments. Upon selection of one or more upsell actions and pressing of the finish button, the selected actions are automatically performed, with relevant fields being automatically populated and relevant communications and updates being automatically delivered.

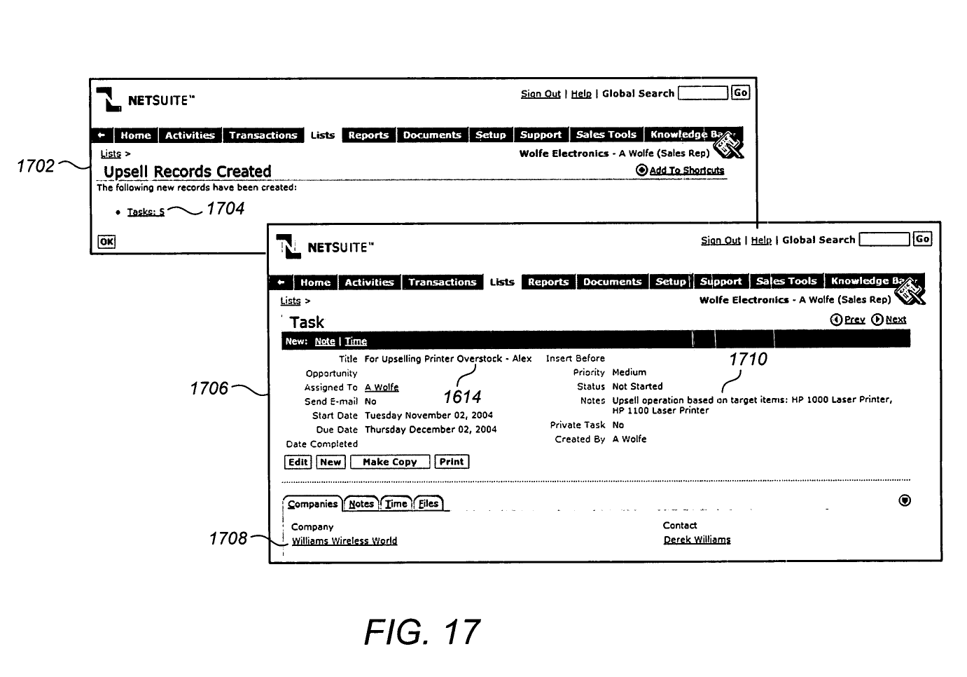

At step 1126 an action verification screen (upsell records created) (see FIG. 17, 1702) is presented that allows the user to verify and view, by clicking one or more links 1704 thereon, the created records or communications. In the particular example presented, tasks were created and routed to enterprise users (sales reps) associated with the selected candidate customers. In this example, the tasks were labeled “For Upselling Printer Overstock—Alex” (see FIG. 16, 1614) by the user of the wizard. The task 1706 has been automatically populated with relevant data including a note 1710 reading, “Upsell operation based on target items: HP1000 Laser Printer, HP1100 Laser Printer,” and including a listing of customers (“Companies”) 1708 with which the recipient of the task is associated. Preferably, the ability for running the upsell wizard and generating such upsell actions, and the ability to have such actions routed to particular types or groups of recipients, is granted to users based on their user role within the web-based information system (e.g., salesperson, sales manager, sales executive, accounts receivable clerk, CEO, etc.), and these settings can be changed on an enterprise-wide basis by a properly authorized person.

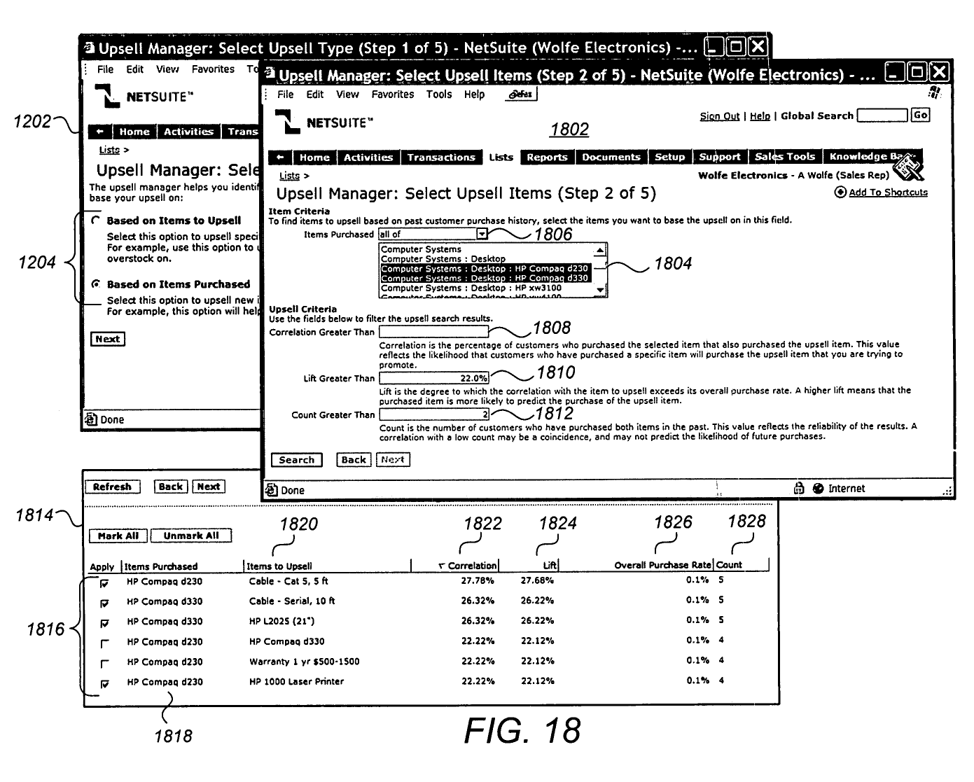

If at step 1106 the user selects “Based on Items Purchased,” then at step 1114 at a second frame of the wizard (see FIG. 18, 1802), a pull-down menu for selecting purchased items (see FIG. 18, 1804) is presented, including an all of/any of menu 1806. In addition to optionally specifying a minimum correlation 1808 and count 1812, the user may also optionally specify a minimum lift parameter 1810. As known in the art, lift is the degree to which the correlation metric between the purchased item and the item to upsell exceeds the overall purchase rate of the item to upsell. A higher lift means that the purchased item is more likely to predict the purchase of the upsell item. Upon pressing of the search button, at step 1116 the second frame is appended with a list 1816 of user-selectable item-wise pairings of source items (items purchased, FIG. 18, 1818) and candidate items (items to upsell, FIG. 18, 1820) according to the entered minimum correlation rate, minimum lift, and minimum count. The list 1816 further identifies correlations 1822, lifts 1824, overall purchase rate 1826 of the candidate items, and counts 1828 associated with the each pairing.

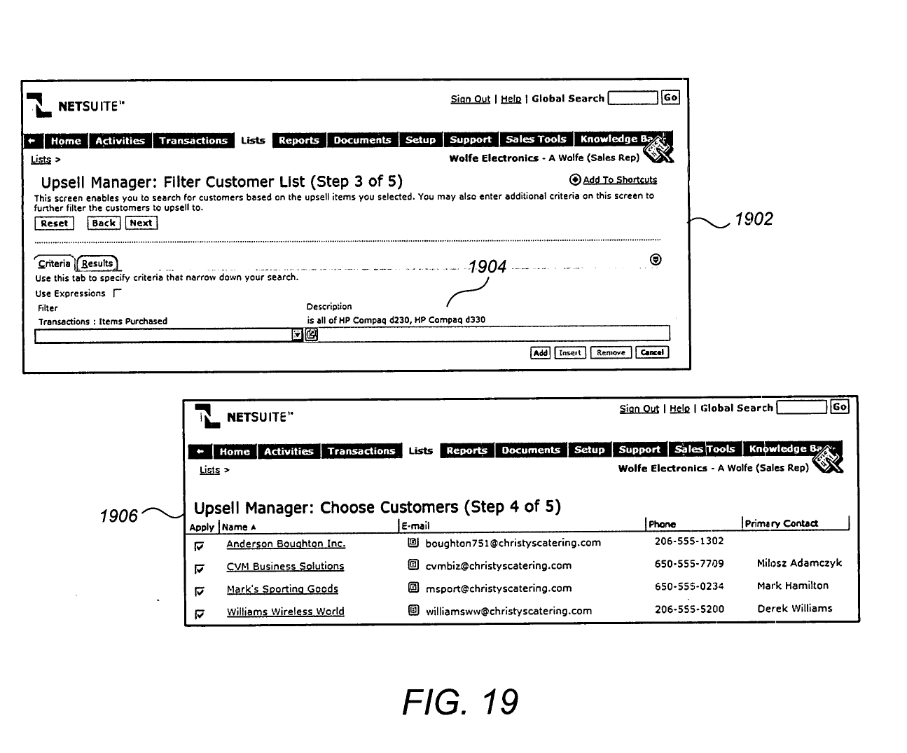

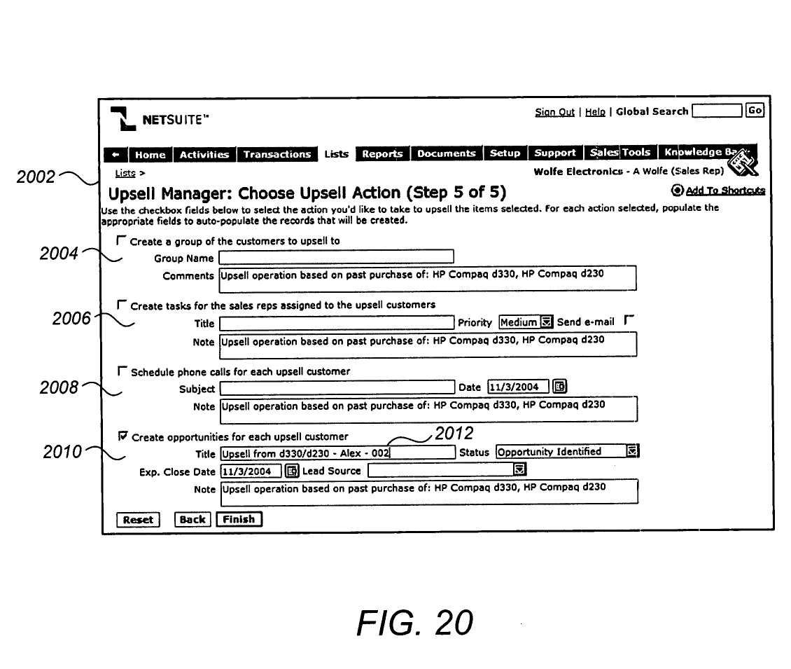

By marking a particular pairing in the list 1816, the user implicates an interest in finding candidate customers who bought that source item (items purchased, FIG. 18, 1818), and who thereby would be more likely to buy that candidate item (item to upsell, 1820). If the user decides at step 1118 to proceed, a third frame providing a pre-populated, user-extensible filter (see FIG. 19, 1902) based on the user's choices is provided at step 1120, and the method proceeds analogously at steps 1122-1126 with reference to FIGS. 19-21. Although not illustrated in FIG. 19, another filter criterion is automatically used specifying that the identified customers have not purchased all of the candidate items (items to upsell, 1820). FIG. 19 illustrates the fourth frame 1906 for selecting the customers to be targeted by the upsell action selection screen of the subsequent frame (FIG. 20, 2002).

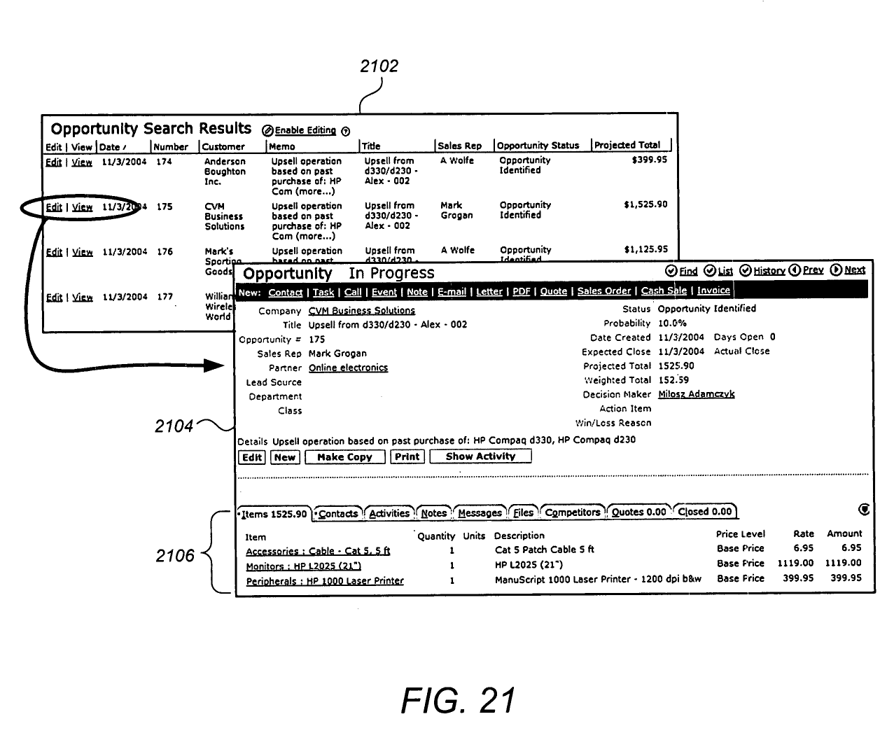

In the example of FIG. 20, an opportunity creation action is chosen. FIG. 21 illustrates a listing 2102 of opportunities automatically created, and further illustrates a particular opportunity record 2104. The opportunity record 2104 has been automatically populated with items 2106 corresponding to the candidate items (items to upsell, 1820) selected by the user at the second frame of the wizard, supra, with items already purchased by that particular customer being omitted. In the general case, the items listed in the different opportunity records among different customers are specific to that customer, showing items that are correlated to which of the source items that customer bought, and accordingly each customer will generally have a different list of items.

Whereas many alterations and modifications of the present invention will no doubt become apparent to a person of ordinary skill in the art after having read the foregoing description, it is to be understood that the particular embodiments shown and described by way of illustration are in no way intended to be considered limiting. Thus, reference to the details of the preferred embodiments are not intended to limit their scope, which is limited only by the scope of the claims set forth below

What is claimed is:

1. A method for facilitating upselling in a web-based business application, comprising:
receiving upsell source parameters from a user in a browser-based user interface of the web-based business application;
displaying an upsell recommendation to the user based upon said upsell source parameters and an upsell information database;
displaying a menu of user-selectable upsell actions for automatic execution by the web-based business application based upon said upsell recommendation;
receiving a selection of one or more of said upsell actions from the user; and
automatically executing each of said selected upsell actions, whereby said automatic execution facilitates at least one enterprise workflow process associated with said upsell recommendation.

2. The method of claim 1, said upsell recommendation identifying at least one upsell customer, wherein said menu comprises an opportunity creation action that, when selected, causes automatic creation of an opportunity record within said web-based business application for each upsell customer.

3. The method of claim 2, wherein said menu further comprises a task creation action that, when selected, causes automatic creation of a task record within said web-based business application, said task record being automatically assigned to an enterprise user having a pre-established association with said upsell customer.

4. The method of claim 3, wherein said menu further comprises:
a phone call scheduling action that, when selected, schedules a phone call with said at least one upsell customer; and
a group creation action that, when selected creates a customer group within said web-based business application including each of said upsell customers.

5. The method of claim 1, wherein said receiving upsell source parameters includes receiving source items, and wherein said receiving upsell source parameters is performed in a wizard interface comprising multiple frames, said frames including:
a first frame requiring the user to select whether said source items are (i) items to upsell, or (ii) items purchased; and
a second frame comprising a pull-down menu for selecting source items among a pre-established listing of enterprise items, said second frame further comprising a desired minimum correlation entry line for user entry of a minimum desired correlation between the source items and a plurality of candidate items in said upsell database, said second frame being dynamically appended with user-selectable item-wise pairings of source items and candidate items according to said minimum correlation rate.

6. The method of claim 5, said wizard interface further comprising a third frame facilitating additional customer filtering entries, said wizard further comprising a fourth frame listing candidate customers identified according to said user-selected item-wise pairings from said second frame, said additional customer filtering entries from said third frame, and said upsell database, wherein said fourth frame displays said candidate customers in a user-selectable manner, said user selections of said candidate customers from said fourth frame forming identified customers within said upsell recommendation.

7. The method of claim 6, wherein said menu comprises an opportunity creation action that, when selected, causes automatic creation of an opportunity record within said web-based business application for each of said identified customers.

8. The method of claim 1, the web-based information system being used by an enterprise having a plurality of customers, said upsell database comprising purchase history information for each of said plurality of customers, said upsell source parameters comprising at least one upsell item, wherein said upsell recommendation identifies one or more customers who purchased at least one candidate item having a minimum degree of customer-wise correlation with said upsell item according to said upsell database, wherein said minimum degree is user-selectable.

9. The method of claim 8, wherein said menu comprises an opportunity creation action that, when selected, causes automatic creation of an opportunity record within said web-based business application for each of said identified customers, said opportunity record being automatically populated with said upsell items.

10. The method of claim 9, wherein said menu further comprises a task creation action that, when selected, causes automatic creation of a task record within said web-based business application, said task record being automatically assigned to an enterprise user having a pre-established association with at least one of said identified customers.

11. A method for facilitating upselling in a web-based business application used by an enterprise, the enterprise selling items and having a population of customers, comprising:
at a server-side processor of the web-based business application, generating an upsell item list for each of a plurality of said customers, each upsell item having a relatively high pairwise, customerwise correlation with at least one other of said items previously purchased by that customer as computed from a history of sales of substantially all of said items to substantially all of said population of customers;
storing said upsell item lists on a server-side storage device of the web-based business application; and
responsive to a single-click or no-click user command into a client-side browser of the web-based business application displaying a customer information record for any of said plurality of customers, delivering the corresponding stored upsell item list to said client-side browser for display.

12. The method of claim 11, further comprising wherein said generating said upsell item list comprises:
computing a customer-wise correlation metric for each of substantially all possible pairings of said items, said customer-wise correlation metric comprising a percentage of customers buying the first member who also bought the second member over a predetermined time interval; and
for each of said plurality of customers, performing the steps of:
identifying each item purchased by the customer over said predetermined time interval;
for each purchased item, identifying a corresponding set of item pairs having relatively high customer-wise correlation metrics, thereby forming a collection of corresponding sets; and
determining said upsell item list based on said collection of corresponding sets.

13. The method of claim 12, wherein said determining further comprises selecting, from said collection of corresponding sets, those items having the highest customer-wise correlation metrics.

14. The method of claim 13, wherein said determining further comprises filtering out items purchased by that customer within said predetermined time interval.

15. A method for facilitating upselling in a web-based business application used by an enterprise, the enterprise selling items, the method comprising:
maintaining a database comprising a correlation metric for each of substantially all possible pairings of items sold by the enterprise;
responsive to a user activity in a browser window of the web-based business application that instantiates a listing of items, providing an upsell option to the user in conjunction with said listing of items; and
upon selection of said upsell option by the user, computing one or more upsell possibilities corresponding to said listing of items according to said correlation metric database, and displaying said upsell possibilities to the user.

16. The method of claim 15, wherein said upsell option comprises a clickable button positioned near said listing of items in said browser window.

17. The method of claim 16, wherein said upsell possibilities are presented in a pop-up window over or near said browser window.

18. The method of claim 15, further comprising:
displaying said upsell possibilities in a format in which each such possibility is individually user-selectable; and
upon user selection of one or more of said possibilities, automatically generating an opportunity record populated with said selected upsell possibilities.

19. The method of claim 15, wherein said listing of items is instantiated in a context of an opportunity record.

20. The method of claim 15, wherein said correlation metric comprises one of a customerwise correlation metric and a transaction-wise correlation metric.
